(19) United States
(12) Patent Application Publication
(10) Pub. No.: US 2006/0149546 A1
(43) Pub. Date: Jul. 6, 2006

(54) Communication system, communication emitter, and appliance for detecting erroneous text messages

(75) Inventors: Fred Runge, Wuensdorf (DE); Christel Mueller, Schulzendorf (DE); Marian Trinkel, Untermaubach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Deutsche Telekom AG, Bonn (DE)

(21) Appl. No.: 10/543,766

(22) PCT Filed: Dec. 19, 2003
(86) PCT No.: PCT/DE03/04189

§ 371 Date: Jul. 28, 2005

(51) Int. Cl. G10L 17/00

(52) U.S. Cl. 704/246

(57) ABSTRACT

A device for detecting erroneous text messages that are produced from a vocal utterance includes a text producing device, a text conversion device associated with the text producing device, and a comparison device. The text producing device produces a text message from an original vocal utterance. The text conversion device converts the produced text message into a converted vocal utterance. The comparison device compares the original vocal utterance to the converted vocal utterance produced by the text conversion device.

The invention relates to a device for detecting erroneous text messages, especially erroneous SMS messages, that are produced from a vocal utterance. The invention also relates to a communication system and to a communication transmitter comprising a device for detecting erroneous text messages.

Dictating machines are well known with which a speech input is converted into a corresponding text signal. The text signals can be stored in the dictating machine and played back, or else they can be transmitted via a communication network to a destination means. A drawback of conventional dictating machines lies in the fact that the user has to verify whether the text produced from a speech input is correct or not.

Therefore, the invention is based on the objective of taking measures with which erroneous text messages that were produced from a vocal utterance can be automatically detected, whereby the attention of a user can optionally be directed to an erroneous text message.

The technical objective is achieved, for one thing, with the features of Claim 1.

According to Claim 1, a device is provided for detecting erroneous text messages, especially SMS messages, that are produced from vocal utterances. The device has a means for producing a text message from at least one original vocal utterance, a means that is associated with the production means and that is used to convert a produced text message into a vocal utterance as well as a comparison means that is associated with the conversion means and that is used for comparing an original vocal utterance to a vocal utterance received in the conversion means. Preferably, the production means is a speech recognition means and the conversion means is a speech synthesis means.

As an alternative, according to Claim 2, a device is provided for detecting erroneous text messages, especially SMS messages, that are produced from vocal utterances. The device has a means for producing a text message from at least one original vocal utterance, a first means for extracting characteristics from a received vocal utterance, a means that is associated with the production means and that is used for converting a produced text message into a vocal utterance, a second means associated with the conversion means for extracting characteristics from a converted vocal utterance as well as a comparison means associated with the first and second extraction means for comparing characteristics of an original vocal utterance to characteristics of a vocal utterance that is produced in the conversion means. The first extraction means can be a component of the production means.

Advantageous refinements are the subject matter of the subordinate claims.

An evaluation means is associated with the comparison means in order to be able to ascertain parameters that represent the error rate or error frequency or else the matching frequency in a text message produced in the production means.

A storage means serves to store an original vocal utterance, a converted vocal utterance, the characteristics extracted from a vocal utterance, the result provided by the comparison means and/or the result provided by the evaluation means.

For example, in order to be able to inform the user of an erroneous text message, a means for conducting a speech dialog with the user is provided, whereby the means for conducting a speech dialog can contain the conversion means or a separate speech synthesis means.

In order for the user to only be informed in case of erroneous text messages, the means for conducting a speech dialog initiates the speech output of a text message to the user depending on the result provided by the evaluation means; these are parameters that represent the error frequency or matching rate of the text message.

It is conceivable, for example, to set the error frequency to a specific value range, whereby the means for conducting a speech dialog initiates the speech output of a text message to the user if the error frequency in a produced text message falls within or outside of the value range, depending on the definition.

In addition, the means for conducting a speech dialog can prompt the user to input one or more erroneous segments within the text message presented.

The technical objective is also achieved with the features of Claim 8.

According to Claim 8, a communication transmitter is provided for sending text messages, especially SMS messages, via at least one network, said transmitter comprising a device for detecting erroneous text messages, according to Claim 1 or 2. The device also comprises an input means for inputting vocal utterances, a means for recognizing and evaluating subscriber numbers, and a means for sending a text message via a communication network to at least one destination means.

Advantageous refinements are the subject matter of the subordinate Claims 9 to 17.

The technical objective is also achieved by the features of Claim 18.

According to Claim 18, a communication system is provided for sending text messages and comprising at least one network, several terminal means that can be connected to the network and that have an input means for inputting vocal utterances, as well as at least one message server that is associated with the network and that, in turn, has a device for detecting erroneous text messages, according to Claim 1 or 2, a means for recognizing and evaluating subscriber numbers and a means for sending a text message to at least one destination means.

The network can be any desired communication network such as, for example, a public telephone system, for example, the ISDN, a cell phone network, a private network or another network that is suitable for transmitting speech signals and/or their characteristics. The destination means can be a message center that forwards the text message coming from the message server to a destination terminal means on the basis of the received destination subscriber number, identification or address. As an alternative, on the basis of the received destination subscriber number, the message server can also transmit the produced text message to the destination terminal means directly or via a network.

Advantageous refinements are the subject matter of the subordinate claims.

The means for producing a text message that is to be sent, referred to below as the producing means, can have a speech recognition means and a means for converting recognized vocal utterances into a character string according to an alphanumeric, preferably a binary character code.

Here, it should be pointed out that any known speech recognition systems and corresponding algorithms for speech recognition can be used. Moreover, mention should be made of the fact that the alphanumeric character code can be, for example, the ASCII code, which is a 7-bit code.

In order to be able to use terminal means that do not have their own displays, the message server has especially a means for conducting a speech dialog with a terminal means, whereby the means for conducting a speech dialog can comprise a control means, the conversion means and/or a separate speech synthesis means. Here, it should also be pointed out that existing speech synthesis means and the corresponding speech synthesis algorithms can be used.

For example, in order to be able to correct a spoken text message at the message server, the means for conducting a speech dialog is configured depending on the result provided by the evaluation means for speech transmission of a text message to the terminal means at which the vocal utterance corresponding to the text message that is to be sent was input. In this manner, it can be ensured that the text message is only transmitted to the terminal means if it is erroneous.

In order to ensure that the vocal utterance that has been input as a text message by the user of a terminal means can be sent error-free by the message server to the terminal means, the means for conducting a speech dialog is configured to prompt the user to confirm the correctness of the text message that is to be sent or to input one or more erroneous segments within the text message that is to be sent.

Another advantage of the communication system lies in the fact that, preferably with speech control, the message server can search a specific passage, especially an erroneous passage, within the text message that is to be sent. For this purpose, the message server has a memory for storing text messages that are to be sent as well as a search means that, in response to one or more specific vocal utterances that have been input at a terminal means, searches for the matching segment within the text message that is to be sent. In this manner, erroneous segments can be corrected in the text message that is to be sent, specific passages can be deleted within the text message that is to be sent and additions can be inserted before and/or after a marked passage within the text message that is to be sent.

At this point, it should be mentioned that the search means can use any known algorithm in order to search for a certain passage, that is to say, a word or group of words, within a text message that is to be sent. For example, matching processes and algorithms are known that can find phonetic similarities between words and that can be used for this purpose.

In order to be able to improve the quality of the search means, a means for translating a foreign-language vocal utterance into the language of the text message that is to be sent can be associated with said search means.

If the search means, in conjunction with the production means, for example, is not able to find a word that is to be corrected within the text message that is to be sent, then the user can input the erroneous word or an erroneous group of words into his terminal means in a language other than the language in which the text message that is to be sent was dictated into the terminal means. After the speech recognition, the word or group of words dictated in a foreign language can be translated by the translation means back into the language of the text message that is to be sent.

Advantageously, the search means has a comparison means for comparing an output signal supplied by the production means to the text message that is to be sent as well as a selection means for selecting a segment within the text message that is to be sent, whereby the selected segment matches the output signal of the production means with a certain probability.

As an alternative, the search means can have a comparison means for comparing an output signal supplied by the production means to the sequence of characteristics that represent a text message that is to be sent. Moreover, the search means has a selection means for selecting characteristics from the sequence of characteristics, whereby the selected characteristics match the output signal of the production means with a certain probability. In addition, there is an adaptation means for converting the selected characteristics into the appertaining segment within the text message that is to be sent or for producing a marking on the basis of the selected characteristics that points to the appertaining segment within the text message that is to be sent. This process is also known as a matching process.

The basic principle of the search means lies in the fact that a specific segment of a vocal utterance that corresponds to the text message that is to be sent has to be input once again at the terminal means and stored in the message server as a search pattern—the search pattern here matches the output signal supplied by the production means—in any desired form, via the recorded speech stream, the character string or any intermediate representation, each corresponding to the text message that is to be sent, in order to search for the specific segment in the text message to be sent.

Moreover, the message server has a means that can delete or replace the segment found by the search means within a text message that is to be sent or else said means can insert a new text segment before and/or after the found segment.

In order to be able to further improve the quality of the speech recognition means and thus also of the search means, it is practical to store user-specific characteristics in the message server that are advantageously stored under an identification of the terminal means of a particular user. The identification can be, for example, a connection identification (CLI, calling line identification), an IP address or an HRL (Home Location Register) for a cell phone. Consequently, a means for recognizing and evaluating such identifications is provided in the message server. The speech recognition means, in response to an identification sent together with a vocal utterance, can access the appropriate user-specific characteristics. The identifications are normally stored in the exchanges or base stations with which the appertaining terminal means are associated.

The invention is explained in greater detail below with reference to several embodiments in conjunction with the drawings. The same reference numerals are used for the same components in the drawings.

The following is shown:

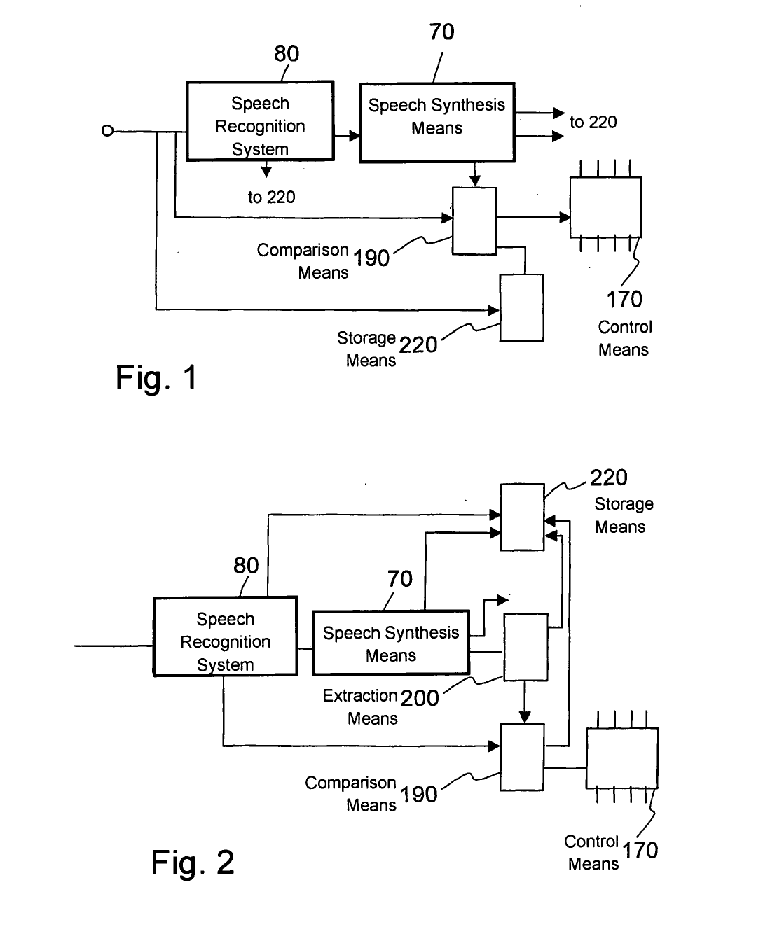

FIG. 1 a schematic depiction of a device for automatically detecting erroneous text messages,

FIG. 2 a schematic depiction of an alternative device for automatically detecting erroneous text messages,

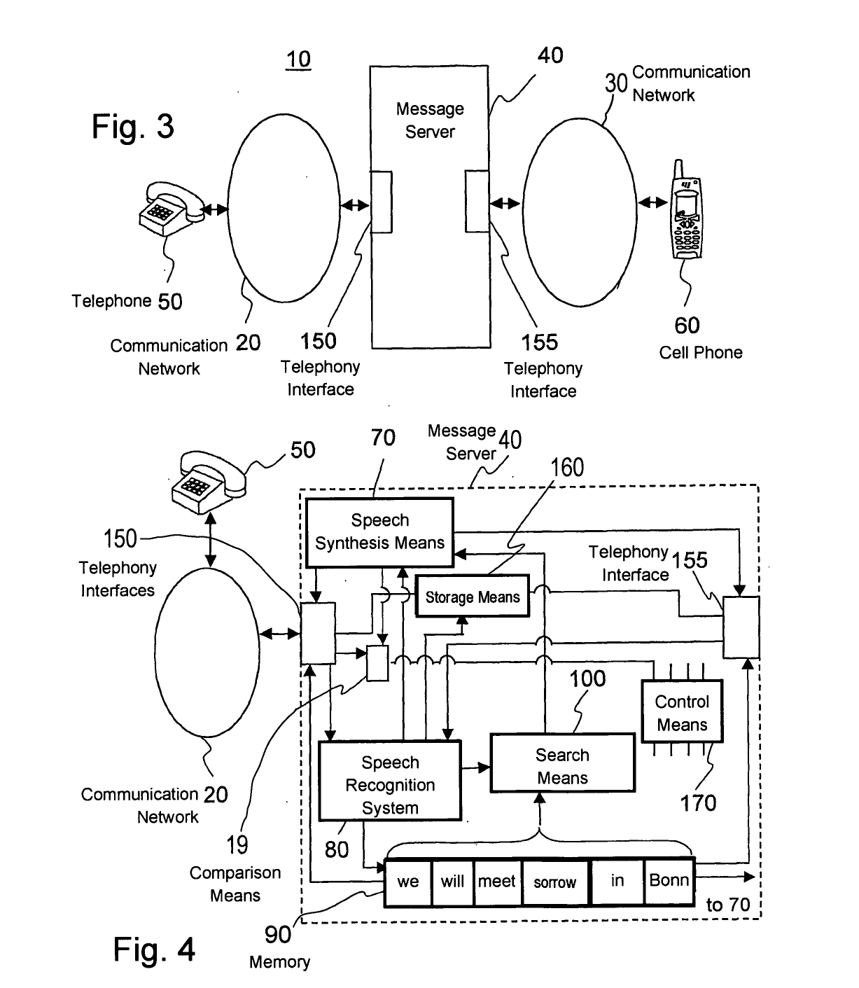

FIG. 3 in a schematic depiction, a communication system according to the invention,

FIG. 4 in sections, the communication system shown in FIG. 3, with an alternative message server,

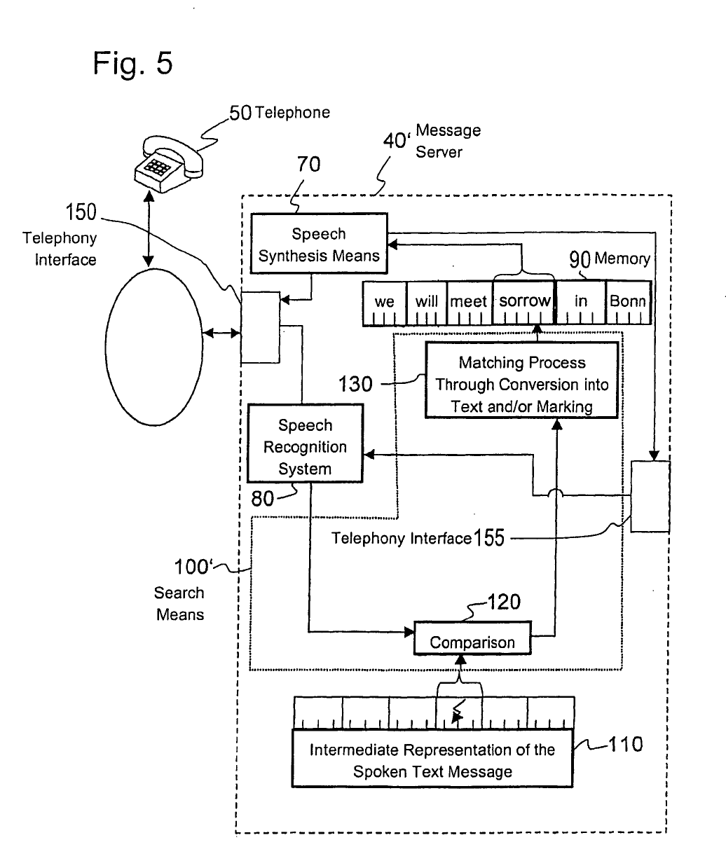

FIG. 5 a sectional depiction of the communication system shown in FIG. 3, with an alternative message server, and

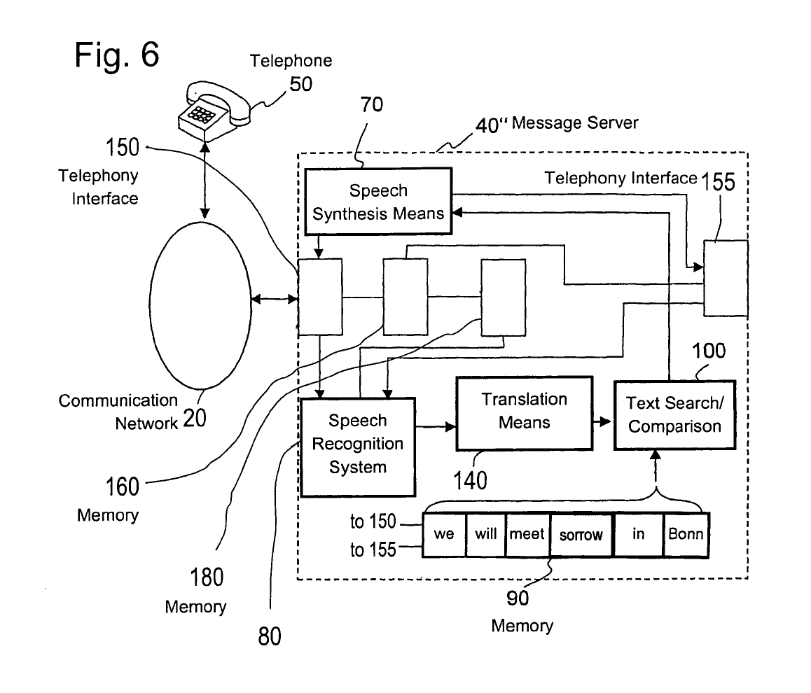

FIG. 6 a sectional depiction of the communication system shown in FIG. 3, with an alternative message server.

FIG. 1 shows a device for automatically detecting an erroneous text message that is to be transmitted, for instance, via a communication network to a destination means. Such a device can be implemented, for example, in a telephone. A vocal utterance input at a microphone (e.g. of a telephone) “We will meet in Bonn tomorrow” is transmitted to a speech recognition system 80 that produces a matching text on the basis of the vocal utterance. Let us assume that the speech recognition system 80 has produced the erroneous text “We will meet in Bonn sorrow” from the received vocal utterance. The erroneous text is transferred to a speech synthesis means 70 that produces the matching speech signal from the erroneous text. The vocal utterance arriving at the input of the speech recognition system 80 is then compared in a comparison means 190 to the vocal utterance present at the output of the speech synthesis means 70. An evaluation means that can be implemented in the comparison means 190 can supply a result that displays the number of erroneous words or letters. As an alternative, the evaluation means can also supply a parameter that represents the error rate or matching rate, for example, in terms of a percentage. The output signals of the speech recognition system 80, of the speech synthesis means 70 and of the evaluation means as well as the vocal utterance received at the speech recognition system 80 can be stored in a storage means 220. The evaluation means is connected to a control means 170 that causes the speech synthesis means 70 to use a loudspeaker (for example, of a telephone) to output the vocal utterance that is stored in the storage means 220 and that was produced from the erroneous text “We will meet in Bonn sorrow”. If the device is implemented in a message server 40 as shown, among other places, in FIG. 4, then the speech synthesis means 70 is not connected to a loudspeaker but rather to telephony interfaces 150 and 155. Subsequently, via the speech synthesis means 70, the control means 170 can output a prompt to the effect that the user should input the erroneous segment or segments within the erroneous text via the microphone.

FIG. 2 shows an alternative device for automatically detecting an erroneous text message in which the speech synthesis means 70 is connected on the output side to an extraction means 200 that extracts characteristics from a vocal utterance, especially acoustic characteristics. Another difference from the device shown in FIG. 1 is that the speech recognition system 80 extracts characteristics from the received vocal utterance “We will meet in Bonn tomorrow”, which are then compared in the comparison means to the characteristics supplied by the extraction means 200. For the rest, the mode of operation of the device is the same as that of the device shown in FIG. 1.

FIG. 3 shows an example of a communication system 10 that has a first communication network 20, a second communication network 30 and a message server 40 associated with both of these communication networks. The message server 40 is connected to the communication network 20 via a telephony interface 150 and to the communication network 30 via a telephony interface 155. The communication network 20 can be a public telephone system, for example, the ISDN, to which, for the sake of simplicity of the depiction, only one telephone 50 is connected. The communication network 30 can be a cell phone network, for example, a GSM network, to which, once again, for the sake of simplicity of the depiction, only one cell phone 60 is connected. Here, it should be mentioned that the communication networks 20 and 30 can be any desired type of network, for example, also private local networks that can be used for transmitting speech signals and/or their characteristics. Furthermore, of course, just one communication network can be used or else more than two communication networks can be connected to the message server 40. The communication system 10 serves to transfer, for example, a vocal utterance that was input at the telephone 50 via the communication network 20 to the message server 40 that then converts the vocal utterance into the matching text message, for example, an SMS message, and then, using the destination subscriber number entered into the telephone 50, transmits this message to the cell phone 60 via the cell phone network 30. Instead of transmitting a text message directly to the cell phone 60, it can be more practical for the message server 40 to first only transmit a message to the cell phone 60 where it is indicated that a text message for the cell phone 60 is present in the message server 40. The message server 40 also comprises the device shown in FIG. 1 or 2 for automatically detecting an erroneous text message that is to be sent.

In this context, it should be pointed out that the message server 40 is at least a speech-controlled server in which, for example, generally known algorithms for speech recognition and/or for speech synthesis are implemented. The above-mentioned telephony interfaces 150 and 155 are capable of receiving and evaluating subscriber numbers and terminal means identifications. The connection identification (CLI) of the telephone 50 is transmitted as an identification, for example, via the communication network 20 to which said telephone 50 is connected, and said identification is stored in the exchange of the communication network 20 associated with the telephone 50. Via the cell phone network 30, for example, the HLR (Home Location Register) identification of the cell phone 60 is transmitted as the identification to the message server 40.

FIG. 4 shows the communication system 10 depicted in FIG. 3 with an example of a message server 40, but without the communication network 30 and without a cell phone 60. The message server 40 has a speech synthesis means 70 that is connected to the telephony interfaces 150 and 155. A speech recognition system 80 is connected on the input side, for example, via a network, to the two telephony interfaces 150 and 155, to a search means 100 and to a memory 90 in which at least one text message that is to be sent is stored as an alphanumeric character string that was converted, for example, to the ASCII code. The memory 90 is connected to the two telephony interfaces 150 and 155, to an input of the speech synthesis means 70 and to the search means 100, for example, via a network. The search means 100 performs a comparison function and a selection function in order to search—as will be explained in detail below—a specific segment from the text message that is to be sent and that is stored in the memory 90. The search means 100 forwards the result to the speech synthesis means 70. A storage means 160 is connected to the two telephony interfaces 150 and 155 and it stores destination subscriber numbers and terminal means identifications of the telephone 50 and of the cell phone 60. If the destination subscriber numbers can be input in speech form into the telephone 50 or into the cell phone 60, then the storage means 160 is connected to the speech recognition system 80 which converts the speech signals into a character string that can then be stored in the storage means 160. A control means 170 carries out the control and monitoring of the message server 40 as well as the forwarding of further information.

Furthermore, the speech recognition system 80 is connected to the speech synthesis means 70. A comparison means 190 containing an evaluation means is connected on the input side to the telephony interface 150 and to the speech synthesis means 70. The evaluation means is connected to the control means 170. This part of the message server 40 forms the device shown in FIG. 1 for automatically detecting an erroneous text message. Of course, the device shown in FIG. 2 can also be implemented in the message server 40. Merely for the sake of a simpler depiction, the storage means 220 has not been drawn.

The mode of operation of the communication system 10 shown in sections in FIG. 4 will be explained in greater detail below. Let us assume that the user of the telephone 50 would like to send a text message, for example, the sentence “We will meet in Bonn tomorrow” to the cell phone 60. For this purpose, the user of the telephone 50 first employs the communication network 20 to request the service for sending text messages. Then the telephone 50 is connected to the message server 40 via the communication network 20. Subsequently, the user dictates the sentence “We will meet in Bonn tomorrow” as well as the subscriber number of the cell phone 60. The spoken text and the subscriber number of the cell phone are transmitted via the communication network 20 to the speech recognition system 80 of the message server 40. The telephony interface 150 or the speech recognition system 80 recognizes the received subscriber number as the subscriber number of the cell phone 60 to which a text message is to be sent. The speech recognition system 80 converts the received subscriber number into a corresponding numeric string and transmits it to the storage means 160. The spoken text message is likewise transmitted to the speech recognition system 80 and converted, for example, according to the ASCII standard code, into the corresponding character string and stored in the memory 90. As shown in FIG. 4, the word “tomorrow” was erroneously recognized as “sorrow”. The speech-controlled message server 40 is implemented in such a way that, first of all, in accordance with the explanations regarding the device shown in FIG. 1, it is ascertained in the comparison means 190 whether the vocal utterance received at the telephony interface 150 “We will meet in Bonn tomorrow” was recognized correctly. For this purpose, the output signals are supplied to the telephony interface and to the speech synthesis means 70 of the comparison means. The evaluation means of the comparison means 190 then determines, for example, the error rate. Only if the determined error rate falls outside of a defined range is the user of the telephone 50 prompted to check and, if necessary, correct the dictated text. For this purpose, the character string that corresponds to the text “We will meet in Bonn sorrow” is supplied to the speech synthesis means 70, which transmits the text as a speech signal via the communication network 20 to the telephone 50, so that the text stored in the memory 90 can be read aloud to the user of the telephone 50. In an advantageous manner, the message server 40 prompts the user of the telephone 50 to confirm the correctness of the text message that was just read aloud or else to once again dictate an erroneous word or word group. The user of the telephone 50 can either input the erroneous word “sorrow” or else already the correct word “tomorrow” into the telephone 50. Let us assume that the user inputs the erroneous word “sorrow” into the telephone 50. The dictated word “sorrow” is once again transmitted via the communication network 20 to the speech recognition system 80 of the message server 40. The speech recognition system 80 converts the dictated word “sorrow” into a character string according to the ASCII standard and compares the generated character string in the search means 100 to the character string stored in the memory 90, which corresponds to the text message that is to be sent. The comparison and selection functions executed by the search means 100 can be based on conventional algorithms such as, for example, algorithms that search for phonetic similarities between words that are to be compared. In the present example, let us assume that the search means 100 has found the word “meet” from the text message that is stored in the memory 90 as the word that has the highest probability of corresponding to the dictated word “sorrow”. The found word “meet” is read out of the memory 90 and transmitted to the speech synthesis means 70 which, in turn, “reads the word aloud” to the user of the telephone 50. Then the user is prompted to confirm the correctness of the found word or else to dictate the erroneous word once again. This search process is repeated until the search means 100 has found the word “sorrow” in the text message stored in the memory 90. Then the user of the telephone 50 is prompted via the speech synthesis means 70 to input the correct word. The user then dictates the word “tomorrow”, which is transmitted to the speech recognition system 80 and then to the search means 100. Subsequently, the search process is carried out as before regarding the term “sorrow” until the user confirms the correctness of the recognized term “tomorrow”.

The message server 40 is configured in such a way that, in response to the confirmation message of the user, it replaces the erroneous word “sorrow” with the correct word “tomorrow” in the memory 90. Now the correct text message can immediately be transmitted to the cell phone 60, making use of the destination subscriber number that is stored in the storage means 160. As an alternative, the text message stored in the memory 90 can also first be transmitted to a text sending center that first merely notifies the cell phone 60 that a new text message is present.

FIG. 5 shows the communication system 10 that is depicted in FIG. 4, with a message server 40′. Merely for the sake of a simpler depiction, the storage means 160, the control means 170, the comparison means 190 and the connections as shown in FIG. 1 have not been drawn here. Diverging from the message server 40, the alternative message server 40′ contains a search means 100′ that has a comparison means 120 and an adaptation means 130 for carrying out a generally known matching process. The comparison means 120 is connected on the input side to a speech recognition system 80 and to a memory 110 in which intermediate representations such as, for example, a sequence of characteristics, correspond to a text message that is to be sent and that is stored in the memory 90. The adaptation means 130 is connected on the output side to a memory 90 in which the text message that is to be sent can be stored as a binary character string.

Below, the mode of operation of the communication system 10 depicted in FIG. 3 will be explained in greater detail. Analogously to the embodiment according to FIG. 2, let us assume that the user of the telephone 50 has requested the service for sending a text message. In response to this, a connection is established between the telephone 50 and the message server 40′ via the communication network 20, hereinafter also called the public telephone system. The user of the telephone 50 does not have to but can be prompted by the message server 40′ to dictate a text message that is to be sent. Once again, let us assume that the user dictates the sentence “We will meet in Bonn tomorrow” into the telephone 50. The corresponding speech signals are transmitted via the communication network 20 to the message server 40′ and supplied to the speech recognition system 80. The speech recognition system 80 is configured in such a way that it acquires from the dictated sentence a character string, for example, according to the ASCII standard code and stores it in the memory 90. Moreover, the speech recognition system 80 extracts from the dictated sentence a so-called intermediate representation of the spoken text message that can represent a sequence of characteristics that are stored in the memory 110. For this purpose, the speech recognition system 80 can have generally known characteristic or phoneme recognition means. First of all, in accordance with the explanations regarding the device shown in FIG. 1, it is ascertained in the comparison means 190 whether it is highly probable that the vocal utterance received at the telephony interface 150 “We will meet in Bonn tomorrow” was recognized correctly. For this purpose, the output signals are supplied to the telephony interface and to the speech synthesis means 70 of the comparison means. The evaluation means of the comparison means 190 then determines, for example, the error rate. Only if the determined error rate falls outside of or within a defined range does the message server 40′ prompt the user of the telephone 50 to confirm the correctness of the dictated text message or else to once again dictate an erroneous word or erroneous word groups. Once again, let us assume that the speech recognition system 80 has recognized the erroneous word “sorrow” instead of “tomorrow” and has stored it in the memory 90 as well as in the memory 110. The user once again inputs into the telephone 50 the word “sorrow” that is to be corrected and that is transmitted via the communication network 20 to the speech recognition system 80 of the message server 40′. The speech recognition system 80 is configured in such a way that it converts the received word “sorrow” into a suitable intermediate representation of characteristics and, in the comparison means 120, compares it to the sequence of characteristics that are stored in the memory 110.

Let us assume this time that the comparison means 120 has selected the characteristics that correspond to the word “sorrow”. The found characteristics are supplied to the adaptation means 130 as an intermediate representation of the searched word “sorrow”. The adaptation means converts the characteristics stored on the input side into a character string that has been encoded with the same character code with which the character string stored in the memory 90 was also encoded. As an alternative, the adaptation means 130 can convert the stored characteristics into a marking that points to the place in the memory 90 where the word “sorrow” is stored. This method is also known as a matching process. Subsequently, the binary character string corresponding to the word “sorrow” is supplied to the speech synthesis means 70, which, from the character string, reads aloud the word “sorrow” to the user of the telephone 50 via the communication network 20. Similar to the embodiment according to FIG. 2, the message server 40′ prompts the user to confirm the word in question, namely, “sorrow”, which was read aloud, or else to once again dictate the word that is to be corrected. Since the user of the telephone 50 confirms that the recognized word is the right one, the message server 40′ can optionally prompt the user to now input the correct word as a vocal utterance. The received vocal utterance “tomorrow” runs through the speech recognition system 80 and is subsequently read aloud to the user on the telephone 50 via the speech synthesis means 70. If a another word instead of the word “tomorrow” was recognized, then the user is prompted again to input the word in question. This method is repeated until the user confirms that the word “tomorrow” has been correctly recognized. As soon as the user has confirmed the correct word “tomorrow”, the erroneous word “sorrow” is replaced in the memory 90 by the correct word “tomorrow”. The text message, which is highly probably correct, can now be sent.

FIG. 6 shows the communication system 10 depicted in FIG. 4, with a message server 40″. Merely for the sake of a simpler depiction, the storage means 160, the control means 170, the comparison means 190 as well as the appropriate connections between the speech synthesis means 70, the speech recognition system 80, the comparison means 190 and the control means 170 have not been drawn here.

FIG. 4 shows sections of the communication system 10 depicted in FIG. 1 with an alternative message server 40″. The message server 40″ is similar to the message server 40 of FIG. 3. Unlike the message server 40, the message server 40″ has a translation means 140 between the speech recognition system 80 and the search means 100 as well as another memory 180 in which user-specific characteristics can be stored. The user-specific characteristics can be addressed via the connection identifications stored in the memory 180 and then forwarded as needed to the speech recognition system 80. The memory 180 is connected to the memory 160 and to the speech recognition system 80. Merely for the sake of a simpler depiction, the control means 170 has not been drawn here. In this context, it should be pointed out that, instead of the search means 100, it is also possible to use the search means 100′ employed in FIG. 3 together with the memory 110 in the message server 40″. In the present example, the destination subscriber number of the cell phone 60 as well as the connection identification (CLI—calling line identification) of the telephone 50 are stored in the memory 160.

The mode of operation of the communication system 10 shown in FIG. 4 is explained in greater detail below.

After a service for sending text messages has been contacted, the telephone 50 is connected to the message server 40″ via the public telephone system 20 and the user speaks the text message “We will meet in Bonn tomorrow” into the telephone 50. The appertaining speech signal is supplied to the speech recognition system 80 which, on this basis, produces a character string and stores it in the memory 90 as an erroneous text message to be sent “We will meet in Bonn sorrow”. The character string is supplied to the speech synthesis means 70 and transmitted as a corresponding speech signal via the communication network 20 to the telephone 50 and read aloud to the user. First of all, in accordance with the explanations regarding the device shown in FIG. 1, it is once again ascertained in the comparison means 190 whether it is highly probable that the vocal utterance received at the telephony interface 150 “We will meet in Bonn tomorrow” was recognized correctly. For this purpose, the output signals of the telephony interface and of the speech synthesis means 70 are supplied to the comparison means. The evaluation means of the comparison means 190 then determines, for example, the error rate. Only if the determined error rate falls outside of or within a defined range does the message server 40″ prompt the user to confirm the correctness of the dictated text message or else to repeat an erroneous word within the text message that is to be sent.

In order to be able to improve the quality of the search means 100, the user dictates in a foreign language that the translation means 140 can understand the word “sorrow”, which is to be corrected. The speech recognition system 80 converts the word received in the foreign language into a character string that is then automatically translated in the translation means 140 into the language of the text message to be sent, which is the German language in the present instance. Here, a selection list of possible words can be generated as the result. In this case, the words can be listed according to their probability and, in the search means 100, they are compared as a search pattern one at a time to the entire text message that is stored in the memory 90. As the result, the word is selected that has the highest probability of being the desired.

Let us assume that, in the text message that is to be sent, the search means 100 has found the word “we” as the word that is to be corrected. The output signal of the search means 100 is supplied to the speech synthesis means 70 which then reads aloud the word “we” to the user of the telephone 50. The user of the telephone 50 then once again dictates the word “sorrow” in the selected foreign language, which is first supplied to the speech recognition system 80, to the translation means 140 and then to the search means 100.

Once again, the word or list of words coming from the translation means 140 is compared one at a time to the entire text that is stored in the memory 90 in the search means 100. Then a certain word is selected on the basis of predefined criteria, for example, the greatest correspondence with a word within the text message that is to be sent. The word found is read aloud to the user of the telephone 50 via the speech synthesis means 70. This procedure is repeated until the user confirms that the word to be corrected, namely, “sorrow” has been found. Subsequently, the user dictates into the telephone 50 the correct word “tomorrow” in the original language or, as an alternative, in a foreign language that the translation means 140 can understand. As soon as the user confirms that the correct word “tomorrow” has been recognized, the message server 40″ ensures that the erroneous word “sorrow” is overwritten in the memory 90 with the correct word “tomorrow”.

In order to improve the quality of the speech recognition, the control means (not shown here) ensures that the connection identification of the telephone 50 that is stored in the memory 160 is provided to the memory 180 and the user-specific characteristics stored there are supplied to the speech recognition system 80. In this manner, a speaker-specific idiosyncrasy can be taken into account.

At this juncture, it should be pointed out that the message servers 40, 40′, 40″ depicted in FIGS. 4, 5 and 6 can be configured in such a way that not only the word to be corrected but also the text message up to the word to be corrected is read aloud to the user of the telephone 50. This capability of the message server is necessary primarily if the text message that is to be sent contains similar words or if one word appears several times. This measure can shorten the duration of the search process.

In an alternative embodiment of the communication system 10, the user spells the correct word and optionally also dictates it as a word, in order to increase the probability that the speech recognition system 80 will recognize the word.

It should be mentioned that the message servers shown in FIGS. 4, 5 and 6 should not be considered separately but rather that the components contained therein can be interchanged at will.

At this juncture, it should also be pointed out that the terminal means 50 and 60, for example, can also be devices that, among other things, can execute an extraction of characteristics from vocal utterances. These characteristics—rather than the vocal utterance—are then supplied to the speech recognition system 80 via the network.

1-27. (canceled)

28. A device for detecting erroneous text messages that are produced from a vocal utterance, comprising:
a text producing device configured to produce a text message from an original vocal utterance;
a text conversion device associated with the text producing device and configured to convert the produced text message into a converted vocal utterance; and
a comparison device configured to compare the original vocal utterance to the converted vocal utterance.

29. The device for detecting erroneous text messages as recited in claim 28 wherein the text messages include SMS messages.

30. The device for detecting erroneous text messages as recited in claim 28 wherein the comparison device is associated with the text conversion device.

31. The device for detecting erroneous text messages as recited in claim 28 wherein the text conversion device includes a first extraction device configured to extract first characteristics from the original vocal utterance and further comprising a second extraction device associated with the text conversion device and configured to extract second characteristics from the converted vocal utterance, wherein the comparison device is configured to compare the first and second characteristics so as to compare the original vocal utterance to the converted vocal utterance.

32. The device for detecting erroneous text messages as recited in claim 31 wherein the comparison device is associated with the first and second extraction devices.

33. The device for detecting erroneous text messages as recited in claim 28 further comprising an evaluation device associated with the comparison device and configured to ascertain parameters that represent an error frequency or a matching frequency in the produced text message.

34. The device for detecting erroneous text messages as recited in claim 31 further comprising a storage device configured to store at least one of an original vocal utterance, a converted vocal utterance, and the first and/or second characteristics.

35. The device for detecting erroneous text messages as recited in claim 33 further comprising a storage device configured to store at least one of the original vocal utterance, the converted vocal utterance, and a result provided by the evaluation device.

36. The device for detecting erroneous text messages as recited in claim 28 further comprising a speech dialog device configured to conduct a speech dialog with a user, the speech dialog device including the text conversion device and a control device.

37. The device for detecting erroneous text messages as recited in claim 36 further comprising an evaluation device associated with the comparison device and configured to ascertain parameters that represent an error frequency or a matching frequency in the produced text message, and wherein the speech dialog device is configured to initiate a speech output of the produced text message to the user based on a result provided by the evaluation device.

38. The device for detecting erroneous text messages as recited in claim 37 wherein the speech dialog device is configured to prompt the user to input one or more erroneous segments of the text message or segments of the text message that have been assessed as being erroneous.

39. A communication transmitter for sending text messages via at least one network, the transmitter comprising:
an error detection device including:
a text producing device configured to produce a text message from an original vocal utterance;
a text conversion device associated with the text producing device and configured to convert the produced text message into a converted vocal utterance; and
a comparison device configured to compare the original vocal utterance to the converted vocal utterance;
an input device configured to input the original vocal utterance;
a number recognition device configured to recognize and evaluate subscriber numbers; and
a text sending device configured to send the produced text message to at least one destination device.

40. The communication transmitter as recited in claim 39 wherein the text messages includes SMS messages.

41. The communication transmitter as recited in claim 39 wherein the error detection device includes an evaluation device associated with the comparison device and configured to ascertain parameters that represent an error frequency or a matching frequency in the produced text message.

42. The communication transmitter as recited in claim 41 further comprising a speech dialog device configured to conduct a speech dialog with a user, the speech dialog device including the text conversion device and a control device.

43. The communication transmitter as recited in claim 39 further comprising a search device configured, in response to an input vocal utterances, to search for a matching segment of the produced text message.

44. The communication transmitter as recited in claim 45 further comprising a translation device associated with the search device and configured to translate a foreign-language vocal utterance into a language of the produced text message.

45. A communication system for sending text messages, comprising
at least one network;
a plurality of terminal devices connectable to the network and each having a respective input device configured to input vocal utterances;
at least one message server associated with the at least one network and having an error detection device including:
a text producing device configured to produce a text message from an original vocal utterance;
a text conversion device associated with the text producing device and configured to convert the produced text message into a converted vocal utterance; and
a comparison device configured to compare the original vocal utterance to the converted vocal utterance; and
a number recognition device configured to recognize and evaluate subscriber numbers; and
a text sending device configured to send the produced text message to at least one destination device.

46. The communication system as recited in claim 50 wherein the message server includes:
a recognition device configured to recognize and evaluate identifications associated with the plurality of terminal devices; and
a storage device configured to store user-specific characteristics under a respective identification of a respective terminal device of the plurality of terminal devices;
wherein the text producing device is configured to access the user-specific characteristics.

47. The communication system as recited in claim 60 wherein the identifications include at least one of a calling line identification, an HLR and an IP address.
